(19) United States
(12) Patent Application Publication
(10) Pub. No.: US 2010/0306670 A1
(43) Pub. Date: Dec. 2, 2010

(54) GESTURE-BASED DOCUMENT SHARING MANIPULATION

(75) Inventors: Kori Marie Quinn, Redmond, WA (US); Rajesh Kutpadi Hegde, Redmond, WA (US); Sharon Kay Cunnington, Sammamish, WA (US); Michel Pahud, Redmond, WA (US); Xuedong D. Huang, Bellevue, WA (US); Zhengyon Zhang, Bellevue, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/474,534

(22) Filed: May 29, 2009

(51) Int. Cl. G06F 3/00; G06F 3/033; G06F 15/16

(52) U.S. Cl. 715/753; 715/863; 709/204

(57) ABSTRACT

The claimed subject matter provides a system and/or a method that facilitates interacting with data associated with a telepresence session. A telepresence session can be initiated within a communication framework that includes two or more virtually represented users that communicate therein. A portion of data can be virtually represented within the telepresence session in which at least one virtually represented user interacts therewith. A detect component can monitor motions related to at least one virtually represented user to identify a gesture, the gesture involves a virtual interaction with the portion of data within the telepresence session. An interaction component can implement a manipulation to the portion of data virtually represented within the telepresence session based upon the identified gesture.

### CROSS-REFERENCE TO RELATED APPLICATIONS

This application is related to pending U.S. patent application Ser. No. 12/399,518 entitled “SMART MEETING ROOM” filed on Mar. 6, 2009. The entirety of the above-noted application is incorporated by reference herein.

### BACKGROUND

Computing and network technologies have transformed many aspects of everyday life. Computers have become household staples rather than luxuries, educational tools and/or entertainment centers, and provide individuals and corporations with tools to manage and forecast finances, control operations such as heating, cooling, lighting and security, and store records and images in a permanent and reliable medium. Networking technologies like the Internet provide individuals virtually unlimited access to remote systems, information and associated applications.

In light of such advances in computer technology (e.g., devices, systems, memory, wireless connectivity, bandwidth of networks, etc.), mobility for individuals has greatly increased. For example, with the advent of wireless technology, emails and other data can be communicated and received with a wireless communications device such as a cellular phone, smartphone, portable digital assistant (PDA), and the like. As a result, physical presence for particular situations has drastically reduced or been reduced. In an example, a business meeting between two or more individuals can be conducted virtually in which the two or more participants interact with one another remotely. Such virtual meetings that can be conducted with remote participants can be referred to as a telepresence session.

With the intense growth of the Internet, people all over the globe are utilizing computers and the Internet to conduct telepresence sessions. Traditional virtual meetings include teleconferences, web-conferencing, or desktop/computer sharing. Yet, each virtual meeting may not sufficiently replicate or simulate a physical meeting. A virtually represented user can interact and communicate data within a telepresence session by leveraging devices with inputs and outputs. One shortcoming associated with conventional telepresence systems is the inherent restrictions placed upon collaboration participants. In essence, participants are traditionally physically bound to narrow confines about the desktop or other device facilitating the collaboration. Moreover, virtual meetings often include or produce a significant amount of data such as, presentations, documents, meeting minutes, topics presented, and the like. Organization of such material and data related to virtual meetings and telepresence sessions can be extremely cumbersome for users who wish to access such information.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate automatically detecting a gesture and interacting with a portion of data within a telepresence based upon such gesture. The subject innovation leverages interactive surfaces in order to provide a richer experience associated with communicating data (e.g., media, documents, PDFs, emails, text, graphics, photos, web links, audio, data files, etc.) to another individual within a telepresence session. In general, a detect component and an interaction component can enable a gesture, such as pushing a document away from you, to trigger data to be communicated or delivered. The recipient of the data can be identified based on the direction or target of the gesture. Moreover, the innovation can automatically identify an optimal medium for the recipient based on user-preferences, communication mediums available, devices available, and the like. Overall, a gesture can provide commands or functions in connection with manipulating data within telepresence sessions.

In one example, there can be two rooms for the telepresence session- a local room and remote room each having a structure (e.g., a wall, sensors, etc.) dividing the two rooms. When a member physically pushes a document through the structure, the document can be communicated to a member(s) within the telepresence session. The document or data can be communicated into a format suited for the recipient (e.g., hard copy, soft copy, attachment, etc.) as well as transmitted in the best suited communication medium (e.g., email, cellular communication, web link, web site, server, SMS message, messenger application, etc.). In other aspects of the claimed subject matter, methods are provided that facilitate manipulating data within a telepresence session based upon a detected gesture.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates manipulating data within a telepresence session based upon a detected gesture.

FIG. 2 illustrates a block diagram of an exemplary system that facilitates automatically detecting a gesture and interacting with a portion of data within a telepresence based upon such gesture.

FIG. 3 illustrates a block diagram of an exemplary system that facilitates delivering data to participants within a telepresence session based upon detected gestures or movements.

FIG. 4 illustrates a block diagram of an exemplary system that facilitates initiating a side conversation between two or more participants within a telepresence session.

FIG. 5 illustrates a block diagram of exemplary system that facilitates enabling two or more virtually represented users to communicate within a telepresence session on a communication framework.

FIG. 6 illustrates a block diagram of an exemplary system that facilitates automatically identifying gestures or motions that initiate an action within a telepresence session.

FIG. 7 illustrates an exemplary methodology for automatically manipulating data within a telepresence session based upon a detected gesture.

FIG. 8 illustrates an exemplary networking environment, wherein the novel aspects of the claimed subject matter can be employed.

FIG. 9 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “data store,” “session,” and the like are intended to refer to a computer-related entity, either hardware, software (e.g., in execution), and/or firmware. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally, cloud services can be employed in which such services may not physically reside on client side hardware but can be accessible. Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

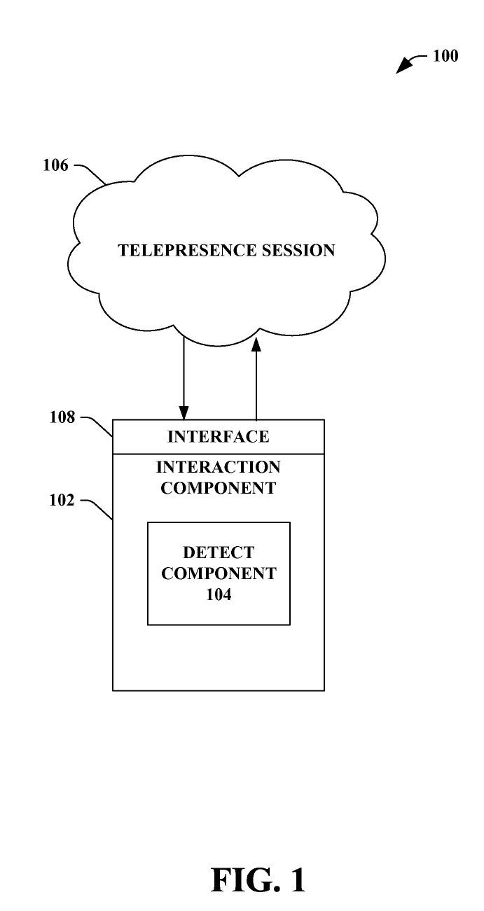

Now turning to the figures, FIG. 1 illustrates a system 100 that facilitates manipulating data within a telepresence session based upon a detected gesture. The system 100 can include a detect component 104 that can detect a gesture or motion from a participant within a telepresence session 106, wherein an interaction component 102 can initiate a data manipulation based upon such detected gesture or motion. In general, the system 100 can monitor a physical user that performs gestures or motions and trigger data manipulations based on such gestures or motions. For instance, the data manipulations can be related to data viewed or utilized within the telepresence session 106, wherein digitally represented participants within the telepresence session 106 can view or experience such manipulations to data. In particular, the detect component 104 can monitor a participant in real time in order to identify gestures, motions, events, and the like. Based on such detections, the interaction component 102 can employ manipulations to data within the telepresence session 106.

For example, the data manipulations can be related to, but not limited to, physical interaction with data virtually represented, drawing attention to data, data delivery to participants, modifications to a location of data (e.g., change page of a document, focus on a particular area of data, etc.), emphasis to data, and the like. Furthermore, the gestures, motions, and/or events that trigger a manipulation to data within the telepresence session 106 can be pre-defined, inferred, trained, dynamically defined, and the like. For instance, gestures, motions, and/or events can be created by a participant, a host of a telepresence session, a server, a network, an administrator, etc. It is to be appreciated that the system 100 can be utilized in connection with surface computing technologies (e.g., tabletops, interactive tabletops, interactive user interfaces, surface detection component, surface detection systems, large wall displays (e.g., vertical surfaces, and the like), etc.), wherein such technologies enable the detection of gestures, motions, events, and the like.

For example, there can be two rooms for the telepresence session—a local room and remote room each having a structure (e.g., a wall, sensors, etc.) that is manipulative and acts as a conduit to the other room although each structure resides in the discreet physical space. The structure can be a detect component and/or device that can monitor participants within the telepresence session in order to identify a performed gesture, motion, and/or event. In particular, when a member physically pushes a document through the structure (e.g., the gesture being a pushing motion with a document), the document can be communicated to a member(s) within the telepresence session. Moreover, the document or data can be communicated into a format suited for the recipient (e.g., hard copy, soft copy, attachment, etc.) as well as transmitted in the best suited communication medium (e.g., email, cellular communication, web link, web site, server, SMS message, messenger application, etc.).

For instance, within a telepresence session, a participant that is digitally represented can perform gestures and/or motions that can emphasize or highlight particular portions of data within the telepresence session. For example, a section or area of a video can be emphasized by a participant by pointing to such section which can initiate a magnification of the section or area during a particular point in the video. In another example, a document can be emphasized with the identification of a particular gesture, wherein the emphasis can be a colored highlight, underline, and the like. Overall, the emphasis can be any suitable modification that draws attention to the portion of data or a section of the portion of data (e.g., circling, underlining, highlighting, color-change, textual manipulation, magnification, font size, boxing, borders, bolding, italicizing, a blinking, a degree of emphasis (e.g., very highlighted versus lightly highlighted, etc.), etc.).

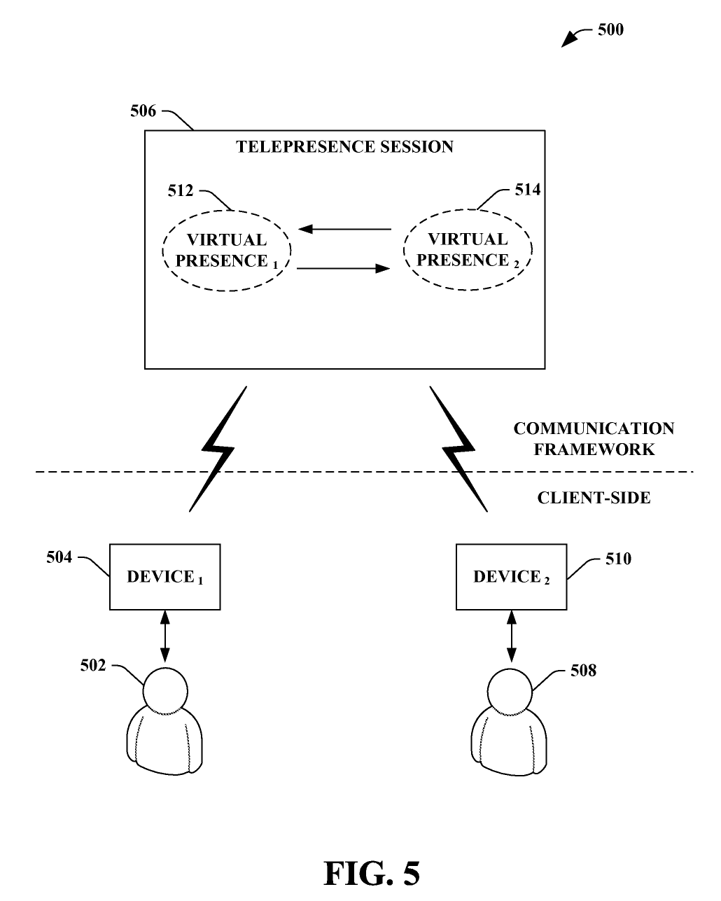

The telepresence session 106 (discussed in more detail in FIG. 5) can be a virtual environment in which two or more virtually represented users can communicate utilizing a communication framework. In general, a physical user can be represented within the telepresence session 106 in order to communicate to another user, entity (e.g., user, machine, computer, business, group of users, network, server, enterprise, device, etc.), and the like. For instance, the telepresence session 106 can enable two or more virtually represented users to communicate audio, video, graphics, images, data, files, documents, text, etc. It is to be appreciated that the subject innovation can be implemented for a meeting/session in which the participants are physically located within the same location, room, or meeting place (e.g., automatic initiation, automatic creation of session, etc.). It is to be appreciated that an attendee can be an actual, physical participant for the telepresence session, a virtually represented user within the telepresence session, two or more physical people within the same meeting room, and the like.

The system 100 can further enable manipulation of physical documents/objects. For example, the system 100 can enable a user to push a paper document on the user's surface to a remote participant in which the telepresence session can make a digital copy and share it with the remote participant. In another example, when a 3D object (e.g., a model car, etc.) is placed on a user's surface and is moved around, the telepresence session can use 3D sensing technology to make a 3D copy and share it with the remote participant and the visualization at the remote side changes with the user's gesture. In general, the system 100 can enable virtual document sharing manipulation as well as conversion of the physical documents/objects into a digital form or medium. In another example, a participant within the telepresence session can push a document through a wall display (e.g., a vertical display, vertical device, etc.).

In addition, the system 100 can include any suitable and/or necessary interface component 108 (herein referred to as “the interface 108”), which provides various adapters, connectors, channels, communication paths, etc. to integrate the detect component 104 and/or the interaction component 102 into virtually any operating and/or database system(s) and/or with one another. In addition, the interface 108 can provide various adapters, connectors, channels, communication paths, etc., that provide for communication with the detect component 104, the interaction component 102, the telepresence session 106, and any other device and/or component associated with the system 100.

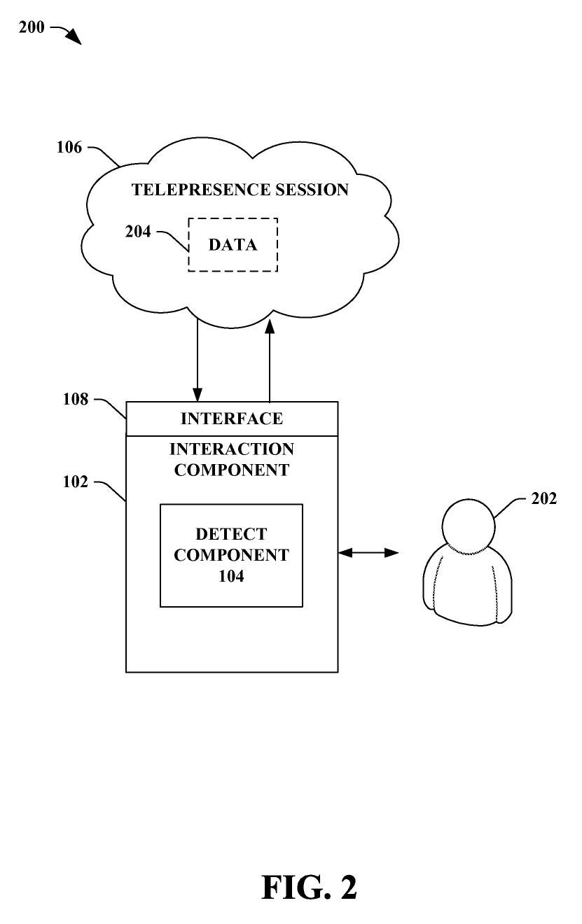

FIG. 2 illustrates a system 200 that facilitates automatically detecting a gesture and interacting with a portion of data within a telepresence based upon such gesture. The system 200 can include the detect component 104 that can monitor a physical user 202 in order to detect a motion, gesture, and/or event that triggers a data manipulation within the telepresence session 106. It is to be appreciated that the physical user 202 can be virtually represented within the telepresence session 106 in order to virtually communicate with other participants (as described in more detail in FIG. 5). Moreover, based upon the detected motion, event, and/or gesture, a portion of data 204 can be manipulated within the telepresence session 106. It is to be appreciated that the portion of data 204 can be, but is not limited to being, a portion of video, a portion of audio, a portion of text, a portion of a graphic, a portion of a word processing document, a portion of a digital image, and/or any other suitable data that can be utilized or viewed within the telepresence session 106.

The detect component 104 can detect real time motion from the user 202. In particular, motion related to the user 202 can be detected as a cue in which such detected motion can trigger at least one of a manipulation or interaction with the portion of data 204 related to the telepresence session 106. The detect component 104 can detect, for example, eye movement, geographic location, local proximity, hand motions, hand gestures, body motions (e.g., yawning, mouth movement, head movement, etc.), gestures, hand interactions, object interactions, and/or any other suitable interaction with the portion of data 204 or directed toward the portion of data 204, and the like. It is to be appreciated that the detect component 104 can utilize any suitable sensing technique (e.g., vision-based, non-vision based, etc.). For instance, the detect component 104 can provide capacitive sensing, multi-touch sensing, etc. Based upon the detection of movement by the detect component 104, the portion of data can be manipulated, interacted, and/or adjusted. For example, the detect component 104 can detect motion utilizing a global positioning system (GPS), radio frequency identification (RFID) technology, optical motion tracking system (marker or markerless), inertial system, mechanical motion system, magnetic system, surface computing technologies, and the like.

In another example, the detect component 104 can leverage speech and/or natural language processing technology. For instance, if a participant says “Look at that!” while pointing somewhere, the detect component 104 can utilize such speech for more confidence that the participant is doing a pointing gesture. In addition, the tone of the voice can be utilized to assist the detect component 104. For instance, an agitated participant might gesture more (e.g., need more filtering) than a participant being more quiet. Information such as the type of meeting can be leveraged by the detect component 104 in order to identify gestures, motions, and the like. For example, a pointing gesture during a brainstorming meeting might mean something else in comparison to a pointing gesture during a presentation type of meeting. The detect component 104 can further utilize cultural information related to participants within the telepresence session 106. Moreover, objects that a participant has in hand while gesturing can also be utilized by the detect component 104 in order to identify motions, gestures, etc. For example, a participant will likely gesture differently while holding a document in comparison to speaking with empty hands.

It is to be appreciated that it can take more than motion detection to understand that the user moved from their seat to the board. It's more of an activity or event detection. Motion detection, sound detection, RFID, infrared etc. are the low level cues that help in activity or event detection or inference. Thus, there can be a plurality of cues (e.g., high level cues and low level cues, etc.) that can enable the identification of a movement, motion, gesture, or event. For example low level cues can be motion detection, voice detection, GPS etc. Whereas a high level cue can be a higher level activity such as walking, speaking, looking at someone, walked up to the board, stepped out of the room, etc.

The detect component 104 can further detect an event in real time, wherein such event can initiate a corresponding manipulation or interaction with the portion of data 204. For example, the event can be, but is not limited to being, a pre-defined command (e.g., a voice command, a user-initiated command, etc.), a topic presented within the telepresence session 106, data presentation, a format/type of data presented, a change in a presenter within the telepresence session 106, what is being presented, a stroke on an input device (e.g., tablet, touch screen, white board, etc.), etc.

It is to be appreciated that the detect component 104 can be any suitable device that can detect motions, gestures, and/or events related to a participant within the telepresence session 106. The device can be, but is not limited to being, a laptop, a smartphone, a desktop, a microphone, a live video feed, a web camera, a mobile device, a cellular device, a wireless device, a gaming device, a portable gaming device, a portable digital assistant (PDA), a headset, an audio device, a telephone, a tablet, a messaging device, a monitor, a camera, a media player, a portable media device, a browser device, a keyboard, a mouse, a touchpad, a speaker, a wireless Internet browser, a dedicated device or surrogate for telepresence, a touch surface, surface computing technologies (e.g., tabletops, interactive tabletops, interactive user interfaces, surface detection component, surface detection systems, etc.), etc. Thus, any suitable gesture, motion, and/or event detected can enable the interaction component 102 to trigger a manipulation with the portion of data 204 within the telepresence session 106.

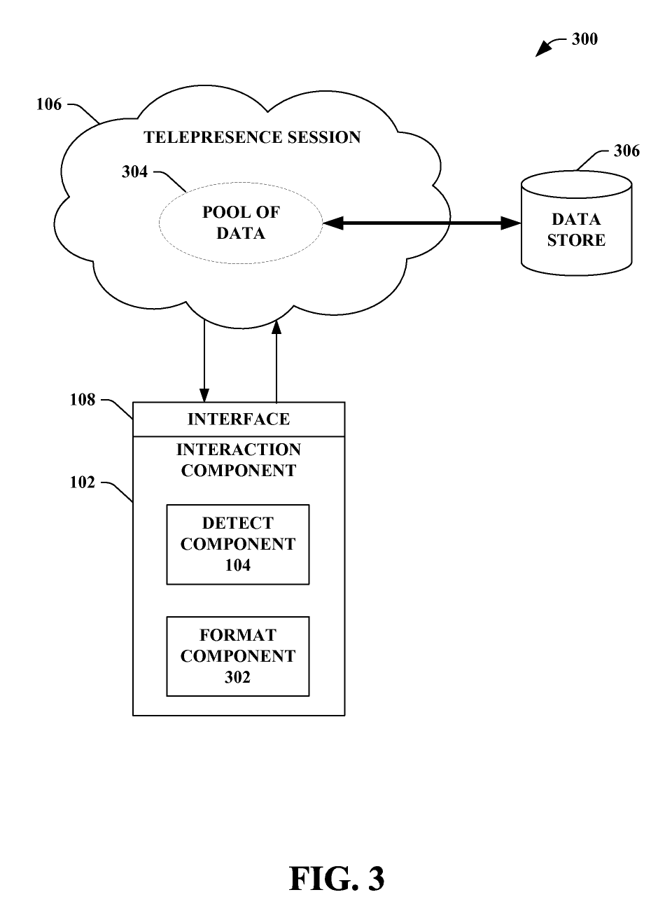

FIG. 3 illustrates a system 300 that facilitates delivering data to participants within a telepresence session based upon detected gestures or movements. The system 300 can include the interaction component 102 that can implement a manipulation to a portion of data within the telepresence session 106 based at least in part upon a detected motion, event, or gesture identified by the detect component 104. In general, the system 300 can enable a gesture, motion, or event to trigger a manipulation to a portion of data within a telepresence session 106 in order to replicate a telepresence session with a real world, physical meeting. For example, a participant can grab a physical document and wave such document in the air—such gesture and motion can trigger such document to be presented (e.g., communicated, delivered, highlighted, drawn attention toward, etc.) to other members or participants within the telepresence session 106.

In another example, an intensity of the gesture, motion, or event can correspond to the amount of manipulation. For instance, a participant can push a document toward another participant with an amount of distance, which can communicate the document to such participant. Yet, pushing the document to another participant with a greater amount of distance can communicate the document to all participants. In addition, waving a document in the air can initiate a level of emphasis or attention to the document, whereas a more intense waving of the document can initiate a higher level (e.g., amount) of emphasis or attention to the document.

The system 300 can include a format component 302 that can facilitate utilizing a gesture to initiate a delivery of a portion of data. In particular, the format component 302 can identify a format (for the data) suited for the recipient (e.g., hard copy, soft copy, attachment, file type, etc.) as well as transmitted in the best suited communication medium (e.g., email, cellular communication, web link, web site, server, SMS message, messenger application, etc.). Thus, the format component 302 can evaluate the available communication modes/mediums and the available resources for recipients, in order to optimally delivery/receipt the data based upon the trigger (e.g., gesture, motion, event, etc.). It is to be appreciated that the format component 302 can automatically format the data and communicate such data over a selected medium based at least in part upon device availability for recipient, inputs/outputs of such available devices, participant preferences (e.g., sender preferences, recipient preferences, etc.), network restrictions (e.g., administrator regulations, server restrictions, security enforcements, etc.), bandwidth for communication mediums, security of communication medium, security level of data to be communicated, physical location, costs for services (e.g., cellular plans, service plans, Internet costs, etc.), etc.

Furthermore, it is to be appreciated that delivery of data can be triggered by gestures performed by a participant distributing the data (e.g., a sender of information) as well as a participant requesting to receive the data (e.g., a recipient of information). Thus, a participant within the telepresence can be presenting spreadsheet, wherein a disparate participant can perform a gesture to initiate receipt of such spreadsheet (e.g., reaching out and pulling the data, etc.). In other words, the subject innovation can include gestures, motions, and/or events from a sender and recipient side in order to employ gender-based delivery of data within the telepresence session 106.

The system 300 can further include a pool of data 304 that can virtually host data within the telepresence session 106. In particular, any suitable data that can be utilized within the telepresence session 106 (e.g., data to be presented, data discussed, referenced data, spreadsheets, documents, videos, audio, web pages, data viewed, data discussed, etc.) can be included within the pool of data 304. In other words, the pool of data 304 can be a universal location for data to be stored, accessed, viewed, and the like by participants within the telepresence session 106. For example, the pool of data 304 can include virtual representations of the data, wherein digitally represented participants can access while within the telepresence session 106. For instance, a text file can be virtually represented (e.g., an image with text file name, a graphic, etc.) can be grabbed by a participant and such document can be communicated to the participant. For example, the data within the pool of data 304 can be virtually represented and represented by at least one of a portion of a graphic, a portion of text, a portion of audio, a portion of video, a portion of an image, and/or any suitable combination thereof. In general, the pool of data 304 can be a central virtual location for data in which participants can read, edit, distribute, view, download from, upload to, etc. It is to be appreciated that the data hosted within the pool of data 304 can include security and authentication protocols in order to ensure safety and data integrity for access as well as uploads and downloads.

The system 300 can further include a data store 306 that can include any suitable data related to the detect component 104, the interaction component 102, the telepresence session 106, the format component 302, the pool of data 304, etc. For example, the data store 306 can include, but not limited to including, defined gestures, user-defined gestures, motions, events, manipulations that correspond to a gesture, manipulations that correspond to a motion, manipulations that correspond to an event, data delivery preferences, data to be presented within a telepresence session, a portion of audio, a portion of text, a portion of a graphic, a portion of a video, a word processing document, data related to a topic of discussion within the telepresence session, data associated with at least one of a virtually represented user (e.g., personal information, employment information, profile data, biographical information, etc.), available devices for communicating within a telepresence session, available communication modes/mediums, settings/preferences for a user, telepresence profiles, device capabilities, device selection criteria, authentication data, archived data, telepresence session attendees, presented materials, any other suitable data related to the system 300, etc.

It is to be appreciated that the data store 306 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 306 of the subject systems and methods is intended to comprise, without being limited to, these and any other suitable types of memory. In addition, it is to be appreciated that the data store 306 can be a server, a database, a hard drive, a pen drive, an external hard drive, a portable hard drive, and the like.

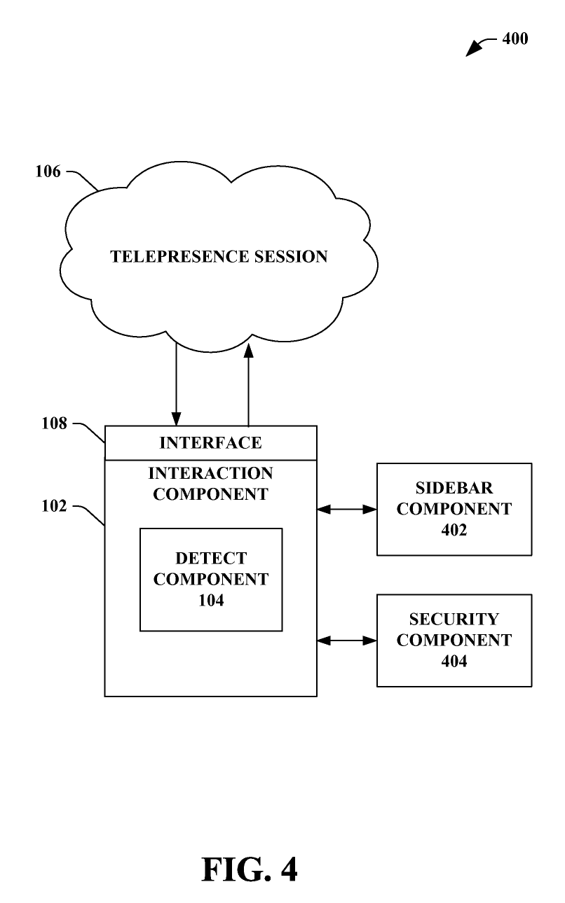

FIG. 4 illustrates a system 400 that facilitates initiating a side conversation between two or more participants within a telepresence session. The system 400 can include the interaction component 102 that can enable data manipulation within the telepresence session 106 based upon a detected gestured identified by the detect component 104. For instance, a gesture can be defined to correspond to delivering data to a participant (e.g., throwing data to a participant within the telepresence session, etc.). In another example, an area or location of the data can be emphasized with a gesture or motion (e.g., a document can be magnified based upon a pointing to such area on the document within the telepresence session, etc.). In still another example, data can be changed based upon a gesture (e.g., a document page can be changed based upon a motion of turning a page, etc.).

The system 400 can further include a sidebar component 402 that enables a virtually represented entity to implement a communication session within the telepresence session 106 with one or more participants. In other words, the sidebar component 402 can enable virtually represented entities (e.g., users, machines, servers, groups, enterprises, etc.) to have a sidebar conversation that includes a subset of the participants within the telepresence session 106, wherein the sidebar conversation can replicate a physical real world sidebar conversation within a courtroom between a judge and counsel. For example, a telepresence session can include participants A, B, and C. Participant A can initiate a communication session within the telepresence session between participants A and B (e.g., excluding participant C). Moreover, the sidebar component 402 can employ a sidebar data communication session within the telepresence session 106 in which data can be communicated and shared within such sidebar. Thus, data can be privately shared or communicated between participants within the telepresence session 106 by utilizing the sidebar component 402. In one example, the sidebar component 402 can enable security with gestures and/or data communication within the side communication session. For example, if participant A and B are in a sidebar communication session discussing/exchanging a document, the gestures of the avatars in the telepresence session can be visible to only participants A and B (or other approved participants). The other avatars/participants can see the avatars of participant A and B as being idle.

The system 400 can further include a security component 404 that can provide security within the telepresence session 106 in terms of data communication. The security component 404 can ensure integrity and authentication in connection with data within the telepresence session 106 and/or users/entities within the telepresence session 106. For example, the security component 404 can ensure authentication and approval is requested for users/entities to access, view, or share data. For example, an enterprise may implement a hierarchy of security in which particular employees have specific levels of clearance. Such hierarchy of security can be enforced for data access within a telepresence session and connectivity to a telepresence session. In another example, users can define sharing settings in which specific lists of participants can access portions of data. Moreover, the security component 404 can employ any suitable security technique in order to ensure data integrity and authentication such as, but not limited to, usernames, passwords, Human Interactive Proofs (HIPS), cryptography, symmetric key cryptography, public key cryptography, etc.

The security component 404 can verify participants/data within the telepresence session 104. For example, human interactive proofs (HIPS), voice recognition, face recognition, personal security questions, and the like can be utilized to verify the identity of a virtually represented user within the telepresence session 106. Moreover, the security component 404 can ensure virtually represented users within the telepresence session 106 have permission to access data identified for the telepresence session 106. For instance, a document can be automatically identified as relevant for a telepresence session yet particular attendees may not be cleared or approved for viewing such document (e.g., non-disclosure agreement, employment level, clearance level, security settings from author of the document, etc.). It is to be appreciated that the security component 404 can notify virtually represented users within the telepresence session 106 of such security issues or data access permissions. Moreover, an owner of data (e.g., a document) can be informed of participants currently in the telepresence session 106 that are not authorized to view and/or modify the document. Additionally, the system 400 can inform the owner of the data prior to the telepresence session 106 if the information of which data will be presented and the list of participants is known ahead of the telepresence session start time. It is to be appreciated that the information of which data will be presented can be extracted from the meeting request and/or other related information.

FIG. 5 illustrates a system 500 that facilitates enabling two or more virtually represented users to communicate within a telepresence session on a communication framework. The system 500 can include at least one physical user 502 that can leverage a device 504 on a client side in order to initiate a telepresence session 506 on a communication framework. Additionally, the user 502 can utilize the Internet, a network, a server, and the like in order to connect to the telepresence session 506 hosted by the communication framework. In general, the physical user 502 can utilize the device 504 in order to provide input for communications within the telepresence session 506 as well as receive output from communications related to the telepresence session 506. The device 504 can be any suitable device or component that can transmit or receive at least a portion of audio, a portion of video, a portion of text, a portion of a graphic, a portion of a physical motion, and the like. The device can be, but is not limited to being, a camera, a video capturing device, a microphone, a display, a motion detector, a cellular device, a mobile device, a laptop, a machine, a computer, etc. For example, the device 504 can be a web camera in which a live feed of the physical user 502 can be communicated for the telepresence session 506. It is to be appreciated that the system 500 can include a plurality of devices 504, wherein the devices can be grouped based upon functionality (e.g., input devices, output devices, audio devices, video devices, display/graphic devices, etc.).

The system 500 can enable a physical user 502 to be virtually represented within the telepresence session 506 for remote communications between two or more users or entities. The system 500 further illustrates a second physical user 508 that employs a device 510 to communicate within the telepresence session 506. As discussed, it is to be appreciated that the telepresence session 506 can enable any suitable number of physical users to communicate within the session. The telepresence session 506 can be a virtual environment on the communication framework in which the virtually represented users can communicate. For example, the telepresence session 506 can allow data to be communicated such as, voice, audio, video, camera feeds, data sharing, data files, etc. It is to be appreciated that the subject innovation can be implemented for a meeting/session in which the participants are physically located within the same location, room, or meeting place (e.g., automatic initiation, automatic creation of session, etc.).

Overall, the telepresence session 506 can simulate a real world or physical meeting place substantially similar to a business environment. Yet, the telepresence session 506 does not require participants to be physically present at a location. In order to simulate the physical real world business meeting, a physical user (e.g., the physical user 502, the physical user 508) can be virtually represented by a virtual presence (e.g., the physical user 502 can be virtually represented by a virtual presence 512, the physical user 508 can be represented by a virtual presence 14). It is to be appreciated that the virtual presence can be, but is not limited to being, an avatar, a video feed, an audio feed, a portion of a graphic, a portion of text, an animated object, etc.

For instance, a first user can be represented by an avatar, wherein the avatar can imitate the actions and gestures of the physical user within the telepresence session. The telepresence session can include as second user that is represented by a video feed, wherein the real world actions and gestures of the user are communicated to the telepresence session. Thus, the first user can interact with the live video feed and the second user can interact with the avatar, wherein the interaction can be talking, typing, file transfers, sharing computer screens, hand-gestures, application/data sharing, etc. In another example, virtual presence such as an avatar, etc. can be combined in real time with the current document(s) to either show the avatar holding the virtual document(s) and/or pointing at the exact location in the document(s) even though the real participant might be just pointing in the air at a document on a display distant from him/her.

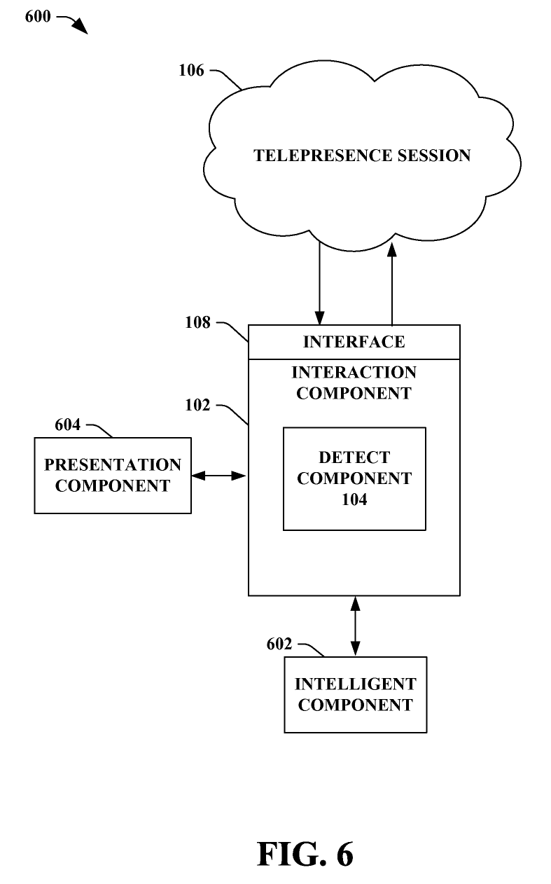

FIG. 6 illustrates a system 600 that employs intelligence to facilitate automatically identifying gestures or motions that initiate an action within a telepresence session. The system 600 can include the interaction component 102, the detect component 104, the telepresence session 106, the interface 108, which can be substantially similar to respective components, interfaces, and sessions described in previous figures. The system 600 further includes an intelligent component 602. The intelligent component 602 can be utilized by the interaction component 102 and/or the detect component 104 to facilitate detecting gestures/motions in order to trigger data manipulation within the telepresence session 106. For example, the intelligent component 602 can infer gestures, motions, events, data delivery formats, selected communication medium delivery, data location for emphasis, type of emphasis to employ for data, delivery settings, user preferences, available devices to receive data communicated, telepresence session settings/preferences, sidebar communication session settings, pool of data configurations, security settings, sharing preferences, authentication settings, etc.

The intelligent component 602 can utilize historic data for each participant in order to increase successful recognition. For example, the intelligent component 602 can leverage historic data to understand that participant A usually shares his/her document/data during status report, participants B and C do side conversations together during telepresence sessions with participant D, and so on and so forth. The intelligent component 602 can further utilize historic data for each participant to help identify which communication medium, devices, etc. to employ. For example, the intelligent component 602 can identify that participant A is on the road during status meetings on a certain day of the week and prefers to use a PDA to communicate with the telepresence session.

The intelligent component 602 can employ value of information (VOI) computation in order to identify formats for data delivery and communication mediums for data delivery. For instance, by utilizing VOI computation, the most ideal and/or appropriate format and communication medium can be determined. Moreover, it is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

The interaction component 102 can further utilize a presentation component 604 that provides various types of user interfaces to facilitate interaction between a user and any component coupled to the interaction component 102. As depicted, the presentation component 604 is a separate entity that can be utilized with the interaction component 102. However, it is to be appreciated that the presentation component 604 and/or similar view components can be incorporated into the interaction component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the interaction component 102. The system 600 can further employ a gesture training component (not shown) that can facilitate training the subject innovation for each participant and his/her needs.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

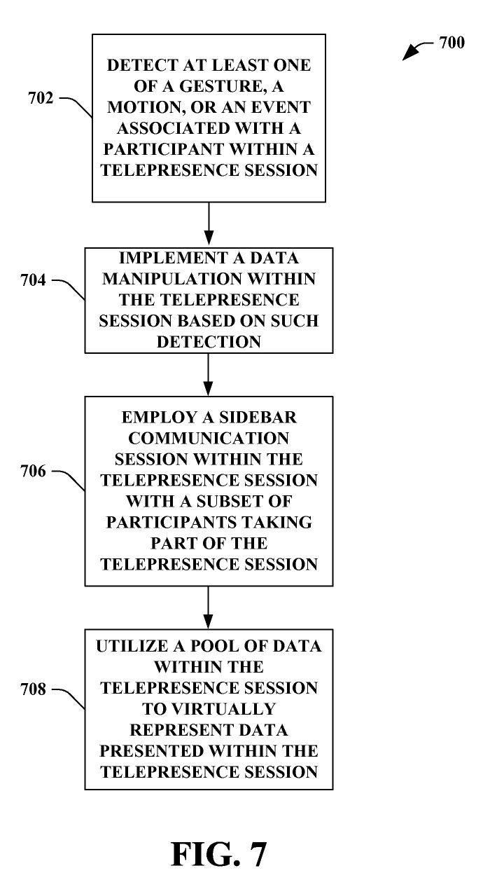

FIG. 7 illustrates a methodology and/or flow diagram in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a method 700 that facilitates manipulating data within a telepresence session based upon a detected gesture. At reference numeral 702, at least one of a gesture, a motion, or an event associated with a participant within a telepresence session can be detected. At reference numeral 704, a data manipulation can be implemented within the telepresence session based on such detection. For example, the data manipulation can be, but is not limited to being, physical interaction with data, drawing attention to data, data delivery to participants, modifications to a location of data (e.g., change page of a document, focus on a particular area of data, etc.), emphasis to data, and the like.

At reference numeral 706, a sidebar communication session within the telepresence session can be employed with a subset of participants taking part of the telepresence session. In general, the sidebar communication can enable a subset of the telepresence session participants to have a private communication while being within the telepresence session. At reference numeral 708, a pool of data can be utilized within the telepresence session to virtually represent data presented within the telepresence session.

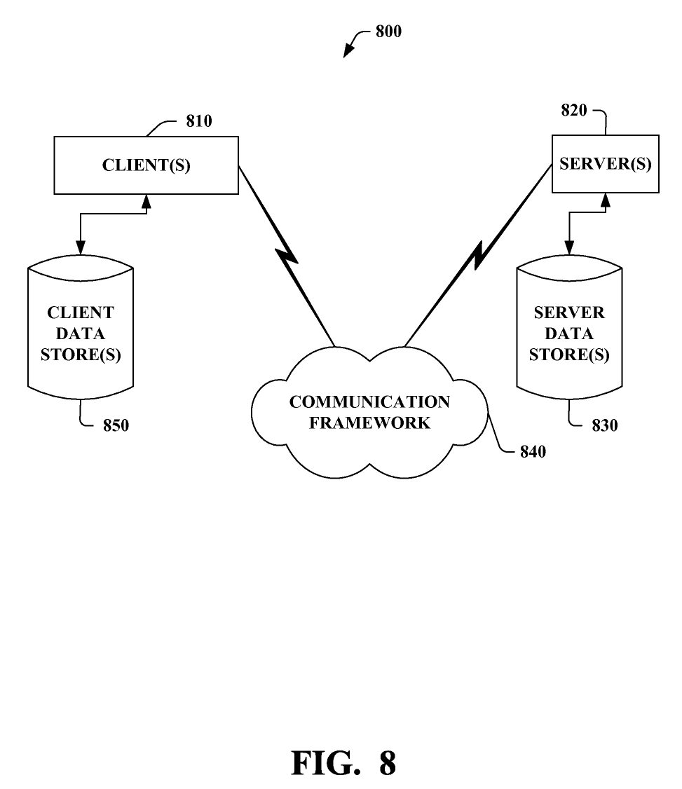

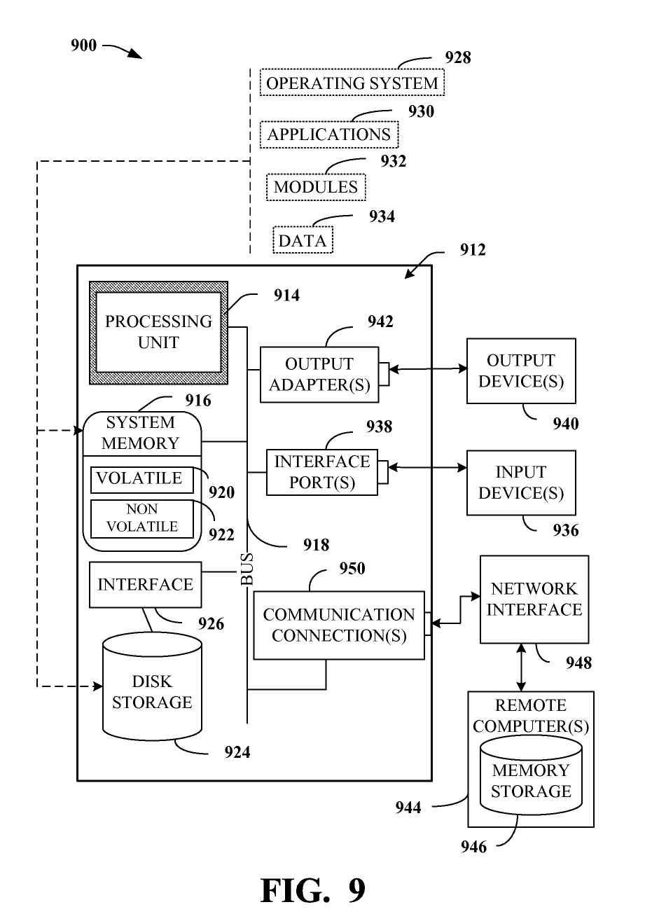

In order to provide additional context for implementing various aspects of the claimed subject matter, FIGS. 8-9 and the following discussion is intended to provide a brief, general description of a suitable computing environment in which the various aspects of the subject innovation may be implemented. For example, a detect component that identifies a gesture from a participant within a telepresence session and an interaction component that implements data manipulation within the telepresence session based on the gesture, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 8 is a schematic block diagram of a sample-computing environment 800 with which the claimed subject matter can interact. The system 800 includes one or more client(s) 810. The client(s) 810 can be hardware and/or software (e.g., threads, processes, computing devices). The system 800 also includes one or more server(s) 820. The server(s) 820 can be hardware and/or software (e.g., threads, processes, computing devices). The servers 820 can house threads to perform transformations by employing the subject innovation, for example.

One possible communication between a client 810 and a server 820 can be in the form of a data packet adapted to be transmitted between two or more computer processes. The system 800 includes a communication framework 840 that can be employed to facilitate communications between the client(s) 810 and the server(s) 820. The client(s) 810 are operably connected to one or more client data store(s) 850 that can be employed to store information local to the client(s) 810. Similarly, the server(s) 820 are operably connected to one or more server data store(s) 830 that can be employed to store information local to the servers 820.

With reference to FIG. 9, an exemplary environment 900 for implementing various aspects of the claimed subject matter includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), or flash memory. Volatile memory 920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in the suitable operating environment 900. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that the claimed subject matter can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates interacting with data associated with a telepresence session, comprising:
a telepresence session initiated within a communication framework that includes two or more virtually represented users that communicate therein;
a portion of data virtually represented within the telepresence session in which at least one virtually represented user interacts therewith;
a detect component that monitors motions related to at least one virtually represented user to identify a gesture, the gesture involves a virtual interaction with the portion of data within the telepresence session; and
an interaction component that implements a manipulation to the portion of data virtually represented within the telepresence session based upon the identified gesture.

2. The system of claim 1, the manipulation is a delivery of the portion of data to at least one virtually represented user within the telepresence session, the delivery is triggered by at least one of the following:
the identified gesture of pushing the portion of data toward the at least one virtually represented user, the pushing is a request to send the portion of data; or
the identified gesture of pulling the portion of data toward the at least one virtually represented user, the pulling is a request to receive the portion of data.

3. The system of claim 2, further comprising a format component that identifies a communication medium for delivery of the portion of data and a format for the portion of data suited for the recipient, the format component evaluates a recipient to which the delivery is targeted to select the communication medium and the format.

4. The system of claim 3, the format component identifies at least one of the communication medium or the format based upon an evaluation of at least one a device availability for recipient, inputs/outputs of an available device, a virtually represented user preferences, sender preference, recipient preference, a network restriction, an administrator regulation, a server restriction, a security enforcement, a bandwidth for a communication medium, a security of communication medium, a security level of data to be communicated, a physical location, a history of participant behavior during the telepresence session, or a cost for a service.

5. The system of claim 2, the interaction component delivers the portion of data to an amount of virtually represented users within the telepresence session based upon at least one of an amount of force used to push the portion of data, an amplitude of the gesture, or a pressure of the gesture.

6. The system of claim 1, the manipulation is a modification to the portion of data perceived by at least one virtually represented user within the telepresence session, the modification is triggered by at least one of the following:
the identified gesture of pointing to the portion of data;
the identified gesture of pointing to a section of the portion of data;
the identified gesture of waving the virtually represented portion of data in the air;
the identified gesture of scrolling the portion of data;
the identified gesture of zooming the portion of data;
the identified gesture of rotating the portion of data;
the identified gesture of grabbing the portion of data;
the identified gesture of holding the virtually represented portion of data in the air; or
the identified gesture of turning a page of the virtually represented portion of data.

7. The system of claim 6, the modification is an emphasis to the portion of data, the emphasis is at least one of a circling, an underlining, a highlighting, a color-change, a textual manipulation, a magnification, a change in font size, a boxing, a border, a bolding, a blinking, a degree of emphasis, or an italicizing.

8. The system of claim 6, the interaction component alerts at least one virtually represented user within the telepresence session that the portion of data requests attention based upon at least one of the identified gesture of waving of the virtually represented portion of data in the air or the identified gesture of holding the virtually represented portion of data in the air.

9. The system of claim 6, the interaction component modifies the portion of data proportional to at least one of an amount of intensity, an amount of force, an amplitude of the gesture, a tone in voice, or an amount of pressure of the gesture, used with at least one identified gesture, the identified gesture is at least one of pointing, waving, holding, scrolling, zooming, rotating, grabbing, or turning the page.

10. The system of claim 1, the gesture is at least one of pre-defined, inferred for each virtually represented user, trained by each virtually represented user, or dynamically defined.

11. The system of claim 1, further comprising a pool of data represented within the telepresence session that virtually hosts the portion of data to enable a universal location within the telepresence session for at least one virtually represented user to access the portion of data.

12. The system of claim 11, the pool of data includes virtual representations of data associated with the telepresence session, the pool of data includes the portion of data and at least one of data presented within the telepresence session, data discussed within the telepresence session, data referenced within the telepresence session, a document, a video, audio, a web page, or data viewed within the telepresence session.

13. The system of claim 11, the data virtually represented within the pool of data is represented by at least one of a portion of a graphic, a portion of text, a portion of audio, a portion of video, or a portion of an image.

14. The system of claim 1, further comprising a sidebar component that employs a communication session, based upon a request, within the telepresence session that includes a subset of the virtually represented users participating within the telepresence session.

15. The system of claim 14, the sidebar component initiates the communication session within the telepresence session as a private communication session for the subset of the virtually represented users.

16. The system of claim 15, the sidebar component enables private data communication, gestures, and sharing between the subset of virtually represented users within the communication session hosted within the telepresence session.

17. A computer-implemented method that facilitates utilizing detected gestures to trigger data manipulations within a telepresence session, comprising:
detecting at least one of a gesture, a motion, a tone of voice, a portion of speech, a combination of tone of voice, speech and a gesture, or an event associated with a participant within a telepresence session;
implementing a data manipulation within the telepresence session based on such detection;
employing a sidebar communication within the telepresence session with a subset of participants taking part of the telepresence session; and
utilizing a pool of data within the telepresence session to virtually represent data presented within the telepresence session.

18. The method of claim 17, the data manipulation is a delivery of data to at least one virtually represented user within the telepresence session, the delivery is triggered by at least one of the following:
the identified gesture of pushing data toward the at least one virtually represented user, the pushing is a request to send data; or
the identified gesture of pulling data toward the at least one virtually represented user, the pulling is a request to receive data.

19. The method of claim 17, the data manipulation is a modification to data within the telepresence session, the modification is perceived by at least one virtually represented user within the telepresence session.

20. A computer-implemented system that facilitates interacting with data associated with a telepresence session, comprising:
means for initiating a telepresence session within a communication framework that includes two or more virtually represented users that communicate therein;
means for virtually representing a portion of data virtually within the telepresence session in which at least one virtually represented user interacts therewith;
means for monitoring motions related to at least one virtually represented user to identify a gesture, the gesture involves a virtual interaction with the portion of data within the telepresence session;
means for identifying a communication medium for delivery of the portion of data and a format for the portion of data suited for the recipient, the format component evaluates a recipient to which the delivery is targeted to select the communication medium and the format;
means for delivering of the portion of data to at least one virtually represented user within the telepresence session based upon the identified gesture, the delivery is triggered by at least one of a pulling gesture of a pushing gesture;
means for utilizing the identified communication medium and the identified format for delivery of the portion of data; and
means for establishing a private communication session for a subset of the virtually represented users, the private communication session is hosted within the communication framework and within the telepresence session.
